(19) United States
(12) Patent Application Publication
(10) Pub. No.: US 2023/0114142 A1
(43) Pub. Date: Apr. 13, 2023

(54) SUPPLY CHAIN MANAGEMENT WITH PART SHORTAGE PREDICTION AND MITIGATION

(71) Applicant: Dell Products L.P., Round Rock, TX (US)

(72) Inventors: Shibi Panikkar, Bangalore (IN); Rohit Gosain, Bangalore (IN); Ajay Maikhuri, Bangalore (IN)

(21) Appl. No.: 17/499,280

(22) Filed: Oct. 12, 2021

(51) Int. Cl. G06Q 10/06; G06Q 50/04; G06Q 30/02

(52) U.S. Cl. CPC G06Q 10/06315; G06Q 50/04; G06Q 30/0201; G06Q 30/0202

(57) ABSTRACT

Automated supply chain management techniques are disclosed. For example, a method comprises obtaining a plurality of datasets respectively representing a plurality of probability measures for a plurality of variability factors associated with a supply chain for at least one part needed to manufacture equipment, and generating a prediction for a future shortage of the at least one part based on the plurality of datasets. The prediction may then be used to proactively mitigate the future shortage.

### FIELD

The field relates generally to information processing systems, and more particularly to supply chain management in such information processing systems.

### DESCRIPTION

Supply chain management in the manufacturing industry typically refers to the process of monitoring and taking actions required for the manufacturer, such as an original equipment manufacturer (OEM), to obtain raw materials, and convert those raw materials into a finished product (equipment) that is then delivered to or otherwise deployed at a customer site. A goal of supply chain management with respect to the raw materials is to adequately balance supply and demand, e.g., the supply of the raw materials (the raw materials procured or otherwise acquired from vendors, etc.) with the demand of the raw materials (e.g., the raw materials needed to satisfy the manufacturing of equipment ordered by a customer). Raw material shortage has been a challenge in the traditional (and even now modern) supply chain process. Though the global supply chain has become more connected and more technologically advanced, it has also had to face a number of new realities with the advent of the global COVID-19 pandemic. Indeed, as with any crisis of this magnitude, society needs to quickly learn where the gaps are in the global supply chain and the ripple effects that those gaps may have.

### SUMMARY

Illustrative embodiments provide automated supply chain management techniques in an information processing system.

For example, in an illustrative embodiment, a method comprises obtaining a plurality of datasets respectively representing a plurality of probability measures for a plurality of variability factors associated with a supply chain for at least one part needed to manufacture equipment. The method then generates a prediction for a future shortage of the at least one part based on the plurality of datasets.

In an illustrative embodiment, the plurality of variability factors may comprise a demand planning factor, a supply planning factor, a supply commitment factor, a supplier commitment versus shipment history factor, a factory inventory feed factor, a market update factor, and a part shortage history by facility factor. The plurality of datasets may be obtained by applying an ensemble of artificial intelligence-based models to the plurality of variability factors. Advantageously, the prediction may then be used to proactively mitigate the future shortage.

Further illustrative embodiments are provided in the form of a non-transitory computer-readable storage medium having embodied therein executable program code that when executed by a processor causes the processor to perform the above steps. Still further illustrative embodiments comprise an apparatus with a processor and a memory configured to perform the above steps.

These and other illustrative embodiments include, without limitation, apparatus, systems, methods and computer program products comprising processor-readable storage media.

### BRIEF DESCRIPTION OF THE DRAWINGS

FIG. 1 illustrates a supply chain management environment with automated parts shortage prediction according to an illustrative embodiment.

FIG. 2 illustrates an automated parts shortage prediction methodology according to an illustrative embodiment.

FIGS. 3-5 collectively illustrate a tabular example of automated parts shortage prediction according to an illustrative embodiment.

FIG. 6 illustrates an example of a processing platform that may be utilized to implement at least a portion of an information processing system for automated parts shortage prediction functionalities according to an illustrative embodiment.

### DETAILED DESCRIPTION

As mentioned above in the background section, the amount of raw material needed to be procured is an ongoing issue for OEMs and other manufacturers in order that they do not experience shortages. By way of example only, raw material that is used to manufacture computing and/or storage equipment ordered by a customer via an OEM may include parts such as, but is not limited to, hard disk drives (HDDs), random access memory (RAM) modules, motherboards, etc.

It is to be appreciated that the meaning of the term “shortage” as illustratively used herein depends on the type of supply chain. For example, shortage may refer to a condition where the supply has fallen below a low threshold quantity (e.g., low water mark). Alternatively or additionally, a shortage can refer to the supply quantity reaching zero. There can be other definitions for a shortage based on the nature of the supply chain and/or the end product being manufactured or deployed.

Naturally, manufacturers want to reduce supply chain risk in any way they can. When it comes to supply shortages in particular, there are a few specific risk factors that might make a disruption more likely. For instance, poor end to end visibility is an issue. If a manufacturer is more aware of what is happening with suppliers and logistics partners, the manufacturer is much more likely to identify potential shortages before they become problems. Data silos (e.g., standalone storage systems containing important information wherein groups or systems that could benefit from the stored information have no access to it) are also an issue whereby if a manufacturer can avoid them, they can effectively use past and real-time data to foresee shortages. Safety stock is also an issue since it involves deciding how much raw material should be stocked for smooth operations to avoid disruption. Normally, safety stock of critical parts is kept very high.

Risk factors outlined above revolve around having the correct information. This is not a coincidence. On the contrary, the ability to collect, store, and analyze the information needed correlates directly with the ability to stave off disruptions of all kinds. Traditionally, an OEM company, such as Dell Technologies and similar organizations with supply chain implantation, use demand capacity planning to find the safety stock water mark. However, with the current disruptions, the “safety stock only” plan would not avoid parts shortages. The safety stock approach is to store more parts than the actual forecasted demand, which can lead to significant overspend. Another approach is to manually view the demand and actuals and come up with an assessed part shortage possibility and take precautions. However, it is realized herein that because of different variabilities, such manual assessments are inaccurate leading to parts shortages in many cases.

Illustrative embodiments overcome the above and other drawbacks by providing systematic prediction of parts shortages based on, but not limited to, the following factors: (i) demand planning; (ii) supply planning; (iii) supply commit; (iv) supplier commitment versus shipment history; (v) factory inventory feed; (vi) market updates; and (vii) part shortage history by facility, which are illustratively explained below.

Demand planning and supply planning: Traditionally, demand and supply planning is the source for the safety stock and that is the existing way to attempt to avoid parts shortages. Typically, based on the demand, manufacturers stock the critical raw material/parts. However, the higher the safety stock, the higher cost for manufacturers. Nonetheless, demand and supply planning can be one of the factors in parts shortage prediction according to illustrative embodiments.

Supply commit: Supply planning gives the forecasting plan to the supplier. However, it is in the supplier's hands as to when to ship it. The supply commit acknowledgement is the commitment that the supplier commits for supplying the raw material in one or more different time intervals. Thus, supply commit can be one of the factors in parts shortage prediction according to illustrative embodiments.

Supplier shipment history versus supplier commitment: While it is good to have the commitment from the supplier, a question to consider is does that supplier fulfill the commitment correctly. Thus, information indicative of the supplier's shipment history compared to the commitment (e.g., was everything that was committed to actually shipped or was there a missed commitment) can be one of the factors in parts shortage prediction according to illustrative embodiments.

Factory inventory feed: while demand planning, supply planning, and supplier fulfillment ability forecasts can be important, the factory inventory (i.e., how much raw material does the factory currently have) can also be critical. Thus, the factory inventory feed can be one of the factors in parts shortage prediction according to illustrative embodiments.

Market updates: Assume that a supplier, logistics support and/or transport are having unforeseen issues due to external market conditions and cannot supply to a manufacturing location. This would be important information for the OEM to know. Thus, market updates can be one of the factors in parts shortage prediction according to illustrative embodiments.

Part shortage history by part by factory: Knowing the history of a shortage that previously occurred for a given part and for a given factory can also be important for the OEM to know. Thus, the history of parts shortage by parts and by factory can be one of the factors in parts shortage prediction according to illustrative embodiments.

Advantageously, in accordance with illustrative embodiments, by considering all or at least a subset of the above factors in a parts shortage prediction methodology and system (e.g., as many factors as are available at the time of prediction), manufacturers such as OEMs are better able to plan and take action to mitigate the shortage, especially in Covid-type situations that drive the supply chain to disruption. It is to be appreciated that while certain factors (also referred to herein as variabilities or variability factors) are described herein in illustrative embodiments, alternative embodiments may consider less, more and/or different factors. As will be further explained, illustrative embodiments compute probability measures for the variability factors to respectively determine likelihoods of a future parts shortage occurring due to the variability factors, and then derive and apply weights to the likelihoods to generate a final prediction of a parts shortage.

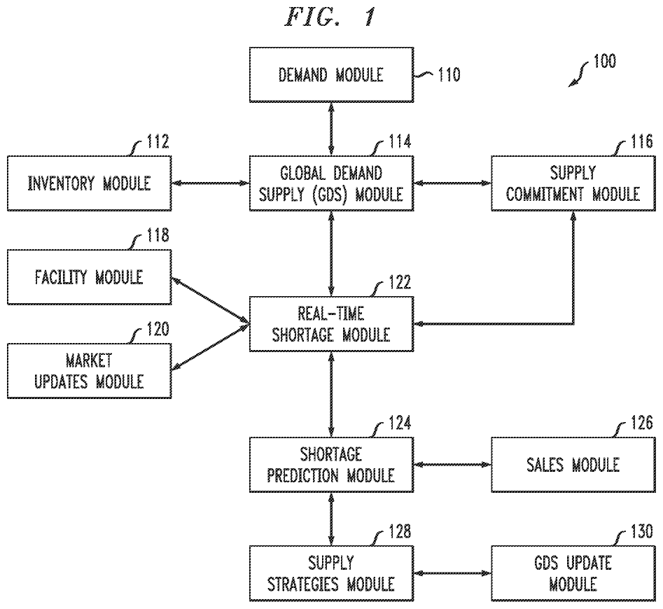

FIG. 1 illustrates a supply chain management environment 100 with automated parts shortage prediction according to an illustrative embodiment. As shown, supply chain management environment 100 comprises a demand module 110, an inventory module 112, a global demand supply (GDS) module 114, a supply commitment module 116, a facility module 118, a market updates module 120, a real-time shortage engine 122, a shortage prediction module 124, a sales module 126, a supply strategies module 128, and a GDS update module 130. The term “module” as illustratively used here can refer to a processing node that performs one or more of the supply chain management functionalities described herein, a source or destination of data such as, for example, a storage unit for such data, or some combination thereof. Embodiments are not intended to be limited to any illustrative definition of a module.

As will be further explained, supply chain management environment 100 is configured to provide systematic prediction of parts shortages based on available factors comprising: (i) demand planning; (ii) supply planning; (iii) supply commit; (iv) supplier commitment versus shipment history; (v) factory inventory feed; (vi) market updates; and (vii) part shortage history by facility. Data for the above factors is provided by one or more modules to one or more other modules shown in supply chain management environment 100. For example, GDS module 114 receives data from inventory module 112, demand module 110, and supplier commitment module 116. Real-time shortage module 122 receives data from GDS module 114, supply commitment module 116, as well as facility module 118 and market updates module 120. Shortage prediction module 124 receives data from real-time shortage module 122 and provides data, for example, in the form of the predicted shortages based on ensemble techniques, as will be further explained herein, to sales module 126 and supply strategies module 128. Supply strategies module 128 provides data to GDS update module 130. An automated parts shortage prediction methodology executed by supply chain management environment 100 is thus able to provide a comprehensive view of total demand and supply planning with segmentation based on with the above factors.

More particularly, GDS module 114 provides data indicative of parts which will be short in an upcoming time period (e.g., day(s), week(s), etc.) based on demand forecast and backlog data provided by demand module 110, data indicative of supplier commitments for the subject parts (what quantity of the subject parts are expected to be available to OEM based on supplier commitments) provided by supply commitment module 116, and data indicative of available inventory for the given parts provided by inventory module 112. GDS module 114 provides the data indicative of parts which will be short in an upcoming time period to real-time shortage module 122.

Actual shortages are reported in real time via facility module 118 to real-time shortage module 122. That is, irrespective of what GDS module 114 historically is indicating, the current shortages are reported by facility module 118 which obtains its information directly from the facility that is manufacturing the equipment that is the end product that results from the supply chain. Thus, for example, information from inventory module 112 and from facility module 118 may differ due to some condition at the facility.

Market updates module 120 provides market-based data from trusted sources (e.g., IDC, etc.) useable to identify suppliers and parts in a manufacturing ecosystem which are likely to go short and/or have gone short. Algorithms such as natural language processing (NLP) can be run by market updates module 120 to extract data from sources about parts and suppliers.

Accordingly, real-time shortage module 122 uses data from supply commitment module 116, facility module 118 and market updates module 120 to compute actual, real-time shortages for subject parts. This real-time shortage data is provided to shortage prediction module 124.

From the historical data on shortages and the data on actual real-time shortages, shortage prediction module 124 predicts shortages using an ensemble of artificial intelligence (AI), machine learning (ML) and/or deep learning (DL) models. For example, based on the supplier commitments (i.e., the quantity) which are going to be received in the future and data on what parts are currently low at the facilities, one or more AI/ML/DL models (algorithms) then predict attributes of the shortage so that the shortage can be mitigated or eliminated before it happens or quickly thereafter.

Thus, it is realized that the above variability factors drive part shortages which can be baselined using the actual part shortage occurring in that planning cycle. Shortage prediction module 124 can track the shortages for critical or all parts with shortages and weights being derived from the above sources. Further, shortage prediction module 124 can derive the probability or percentage which will tells how much confidence there is in the prediction.

User-defined thresholds can be used as benchmarks for reporting shortages for proactive decisions for building supply chain strategies (supply strategies module 128) such as onboarding new suppliers or getting the material from another location depending upon the lead time. GDS update module 130 can then update the overall GDS view and report it to GDS module 114 as part of a feedback loop. Also, sales applications in sales module 126 can perform demand shaping for a better customer experience. With the functionalities of supply chain management environment 100, supply chain users are enabled to proactively work on shortages which will help to build new or a revised supply chain strategies with the suppliers.

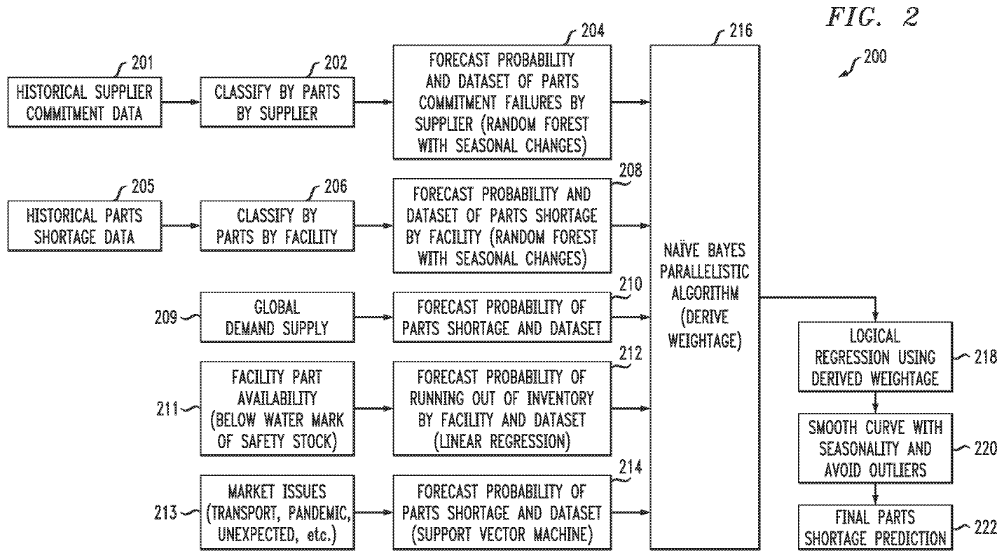

FIG. 2 illustrates an automated parts shortage prediction methodology 200 according to an illustrative embodiment. Automated parts shortage prediction methodology 200 can be executed in or under the control of one or more modules of supply chain management environment 100 of FIG. 1, as well as in alternative information processing systems.

More particularly, as shown, historical supplier commitment data 201 is applied to step 202 which classifies the historical supplier commitment data 201 by parts and by supplier. The classifications from step 202 are then used in a random forest algorithm with seasonal changes in step 204 to generate a forecast probability and a corresponding dataset of parts commitment failures by supplier.

Similarly, historical parts shortage data 205 is applied to step 206 which classifies the historical parts shortage data 205 by facility. The classifications from step 206 are then used in a random forest algorithm with seasonal changes in step 208 to generate a forecast probability and a corresponding dataset of parts shortage by facility.

Further, global demand supply data 209 is applied to step 210 which generates a forecast probability of parts shortages and a corresponding dataset, while facility part availability data (identifying parts below the low threshold water mark of the safety stock) 211 is applied to step 212 which uses a linear regression algorithm to generate a forecast probability of running out of inventory by facility and a corresponding dataset.

Still further, data 213 indicative of issues that may affect supply, such as, but not limited to, transport conditions, pandemic related issues, and/or any unexpected problems, are applied to step 214 which uses a support vector machine (SVM) algorithm to generate a forecast probability of parts shortages and a corresponding data set.

The corresponding datasets representing the forecasted probabilities of the variability factors associated with steps 204, 208, 210, 212 and 214 are then applied to step 216 which executes a Naïve Bayes parallelistic algorithm to derive weightage. This means that each dataset representing a respective variability factor is given a weight. Step 218 uses the derived weights to apply a logical regression algorithm, and step 220 smooths the results (curve) based on seasonality changes and removes any outliers. The final parts shortage prediction is made available in step 222 and can be used, for example, to make proactive sales and supply strategy decisions and to update the overall GDS view. Automated parts shortage prediction methodology 200 can be iterated one or more times as explained above.

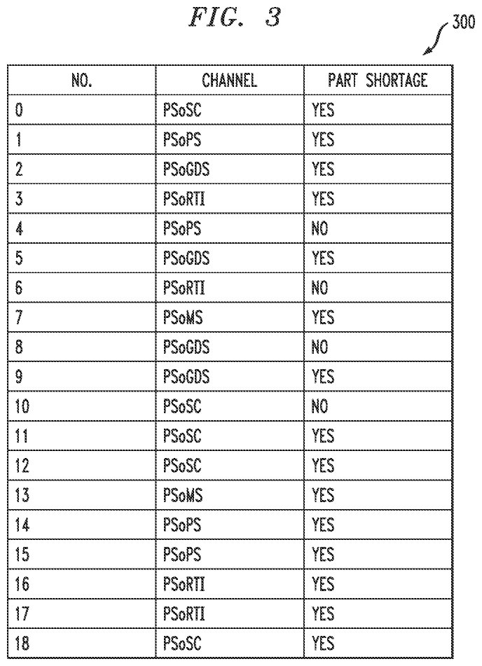

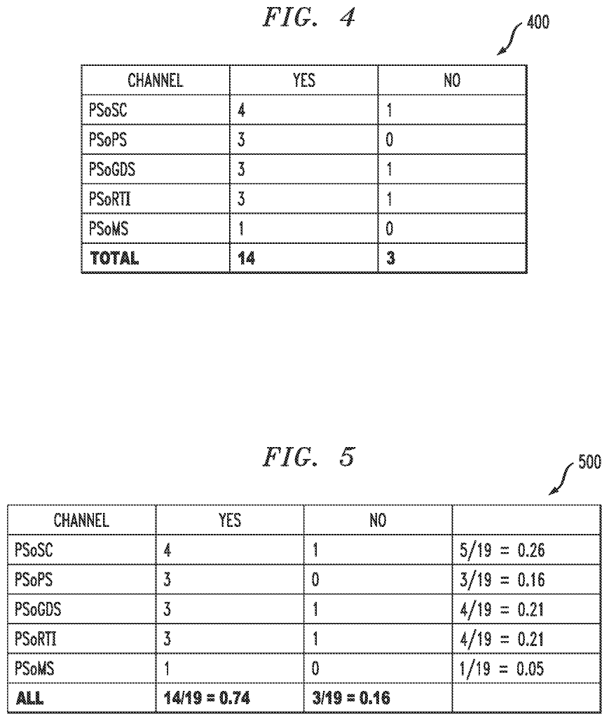

FIGS. 3-5 collectively illustrate a tabular example (tables 300, 400 and 500) of an automated parts shortage prediction methodology according to an illustrative embodiment. The tabular example gives an illustrative representation of the datasets (also referred to as data channels) generated and used in accordance with automated parts shortage prediction methodology 200 to generate a final parts shortage prediction.

Recall, as shown in steps 202 and 204 of FIG. 2, the methodology obtains historical supplier commitments and a history of the suppliers fulfilling the commitments, and classifies missed commitments by parts and by supplier. In illustrative embodiments, a Bayesian network (e.g., random forest) with seasonal changes is used for predicting missed commitments for each supplier and part. The methodology creates a dataset representing the probability of each supplier missing a parts commitment and any actual missing of a parts commitment. This resulting dataset is referred to as a Part Shortage Indicator Based on Supplier Commitment or PSoSC data channel.

Similarly, recall that in steps 206 and 208 of FIG. 2, the methodology obtains historical parts shortage data and classifies the shorted parts data by facility. In illustrative embodiments, a Bayesian network (e.g., random forest) with seasonal changes is used to predict parts shortages for each facility and part for a particular end product (equipment being manufactured). The resulting dataset is created representing a probability of parts shortage by facility and actual parts shortages that have occurred and is referred to as Part Shortage Indicator Based on Historical Part Shortage or PSoPS data channel.

Also, recall as shown in step 210 of FIG. 2, the methodology takes GDS data and generates a parts shortage probability based on the GDS data. The resulting dataset is referred to a Part Shortage Indicator Based on GDS or PSoGDS data channel.

Further, recall as shown in step 212 of FIG. 2, real-time facility feed data is used to predict the inventory variation by facility by part. The resulting dataset representing inventory status and actual parts shortage by facility by part is referred to as Part Shortage Indicator Based on Facility Inventory or PSoRTI data channel.

Still further, recall as shown in step 214 of FIG. 2, an SVM algorithm is used to take into account real-time market issues. The resulting dataset is referred to as Part Shortage Indicator Based on Market Status or PSoMS data channel.

Once a dataset is generated for each variability factor against the actual occurrence of a part shortage, recall that step 216 of FIG. 2 uses a Naïve Bayes algorithm to derive the weightage for each variability factor. Then, recall steps 218 through 222, take the derived weightage in the individual part shortage prediction and use a simple logistic (logical) regression by applying the weights derived to get the final shortage prediction considering all variability factors.

Tables 300, 400 and 500 illustrate how a Näive Bayes algorithm is used to derive weightage in the context of the impact of supplier commitment. The methodology determines (or answers), given a deviation of a supplier commit (missed commitment), what is the probability that there would be an actual part shortage. As shown, for the data channels shown in table 300, datasets are converted into a frequency table (table 400) for a given part. Note that Part_Shortage in table 300 is the actual parts shortage that occurred.

First assume that a supplier for the given part committed and did not deliver, and an actual part shortage occurred. Thus, the tabular example shows:

P(Yes|PSoSC)=P(PSoSC|Yes)*P(Yes)/P(PSoSC)

P(PSoSC|Yes)=4/14=0.29

P(PSoSC)=0.26

P(Yes)=0.74

So, P(Yes|PSoSC)=0.29*0.74/0.26=0.83

Now assume that a supplier for the given part committed and did not deliver, but an actual part shortage did not occur. Thus, the tabular example shows:

P(No|PSoSC)=P(PSoSC|No)*P(No)/P(PSoSC)

P(PSoSC|No)=1/14=0.07

P(No)=0.16

So, P(No|PSoSC)=0.07*0.16/0.26=0.04

Thus, note that P(Yes|PSoSC)>P(No|PSoSC)

Accordingly, the methodology would predict that if the supplier committed and did not deliver, an actual part shortage would occur.

Thus, a weightage would be: P(Yes|PSoSC)/P(No|PSoSC)=0.83/0.04=20.75

Similarly, each other dataset (data channel) is processed in this way to derive weightage.

All part shortage predictions are accumulated with weights applied and the logistic regression is executed to obtain the final part shortage prediction for the given part. The final prediction is returned to the GDS model (e.g., GDS module 114 of FIG. 1) to update the GDS view and the OEM can take appropriate action(s) as part of a proactive mitigation plan.

Illustrative embodiments are described herein with reference to exemplary information processing systems and associated computers, servers, storage devices and other processing devices. It is to be appreciated, however, that embodiments are not restricted to use with the particular illustrative system and device configurations shown. Accordingly, the term “information processing system” as used herein is intended to be broadly construed, so as to encompass, for example, processing systems comprising cloud computing and storage systems, as well as other types of processing systems comprising various combinations of physical and virtual processing resources. An information processing system may therefore comprise, for example, at least one data center or other type of cloud-based system that includes one or more clouds hosting tenants that access cloud resources. Cloud infrastructure can include private clouds, public clouds, and/or combinations of private/public clouds (hybrid clouds).

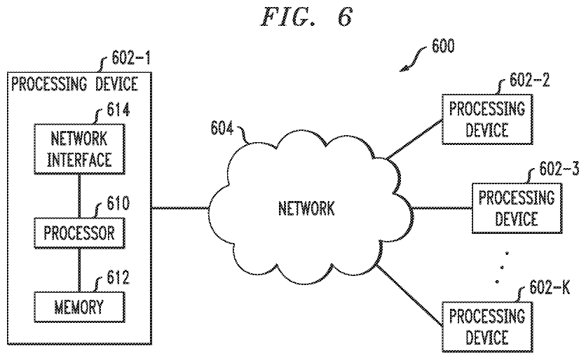

FIG. 6 depicts a processing platform 600 used to implement information processing systems/processes 100 through 500 depicted in FIGS. 1 through 5, respectively, according to an illustrative embodiment. More particularly, processing platform 600 is a processing platform on which a computing environment with functionalities described herein can be implemented.

The processing platform 600 in this embodiment comprises a plurality of processing devices, denoted 602-1, 602-2, 602-3, . . . 602-K, which communicate with one another over network(s) 604. It is to be appreciated that the methodologies described herein may be executed in one such processing device 602, or executed in a distributed manner across two or more such processing devices 602. It is to be further appreciated that a server, a client device, a computing device or any other processing platform element may be viewed as an example of what is more generally referred to herein as a “processing device.” As illustrated in FIG. 6, such a device generally comprises at least one processor and an associated memory, and implements one or more functional modules for instantiating and/or controlling features of systems and methodologies described herein. Multiple elements or modules may be implemented by a single processing device in a given embodiment. Note that components described in the architectures depicted in the figures can comprise one or more of such processing devices 602 shown in FIG. 6. The network(s) 604 represent one or more communications networks that enable components to communicate and to transfer data therebetween, as well as to perform other functionalities described herein.

The processing device 602-1 in the processing platform 600 comprises a processor 610 coupled to a memory 612. The processor 610 may comprise a microprocessor, a microcontroller, an application-specific integrated circuit (ASIC), a field programmable gate array (FPGA) or other type of processing circuitry, as well as portions or combinations of such circuitry elements. Components of systems as disclosed herein can be implemented at least in part in the form of one or more software programs stored in memory and executed by a processor of a processing device such as processor 610. Memory 612 (or other storage device) having such program code embodied therein is an example of what is more generally referred to herein as a processor-readable storage medium. Articles of manufacture comprising such computer-readable or processor-readable storage media are considered embodiments of the invention. A given such article of manufacture may comprise, for example, a storage device such as a storage disk, a storage array or an integrated circuit containing memory. The term “article of manufacture” as used herein should be understood to exclude transitory, propagating signals.

Furthermore, memory 612 may comprise electronic memory such as random-access memory (RAM), read-only memory (ROM) or other types of memory, in any combination. The one or more software programs when executed by a processing device such as the processing device 602-1 causes the device to perform functions associated with one or more of the components/steps of system/methodologies in FIGS. 1 through 5. One skilled in the art would be readily able to implement such software given the teachings provided herein. Other examples of processor-readable storage media embodying embodiments of the invention may include, for example, optical or magnetic disks.

Processing device 602-1 also includes network interface circuitry 614, which is used to interface the device with the networks 604 and other system components. Such circuitry may comprise conventional transceivers of a type well known in the art.

The other processing devices 602 (602-2, 602-3, . . . 602-K) of the processing platform 600 are assumed to be configured in a manner similar to that shown for computing device 602-1 in the figure.

The processing platform 600 shown in FIG. 6 may comprise additional known components such as batch processing systems, parallel processing systems, physical machines, virtual machines, virtual switches, storage volumes, etc. Again, the particular processing platform shown in this figure is presented by way of example only, and the system shown as 600 in FIG. 6 may include additional or alternative processing platforms, as well as numerous distinct processing platforms in any combination.

Also, numerous other arrangements of servers, clients, computers, storage devices or other components are possible in processing platform 600. Such components can communicate with other elements of the processing platform 600 over any type of network, such as a wide area network (WAN), a local area network (LAN), a satellite network, a telephone or cable network, or various portions or combinations of these and other types of networks.

Furthermore, it is to be appreciated that the processing platform 600 of FIG. 6 can comprise virtual (logical) processing elements implemented using a hypervisor. A hypervisor is an example of what is more generally referred to herein as “virtualization infrastructure.” The hypervisor runs on physical infrastructure. As such, the techniques illustratively described herein can be provided in accordance with one or more cloud services. The cloud services thus run on respective ones of the virtual machines under the control of the hypervisor. Processing platform 600 may also include multiple hypervisors, each running on its own physical infrastructure. Portions of that physical infrastructure might be virtualized.

As is known, virtual machines are logical processing elements that may be instantiated on one or more physical processing elements (e.g., servers, computers, processing devices). That is, a “virtual machine” generally refers to a software implementation of a machine (i.e., a computer) that executes programs like a physical machine. Thus, different virtual machines can run different operating systems and multiple applications on the same physical computer. Virtualization is implemented by the hypervisor which is directly inserted on top of the computer hardware in order to allocate hardware resources of the physical computer dynamically and transparently. The hypervisor affords the ability for multiple operating systems to run concurrently on a single physical computer and share hardware resources with each other.

It was noted above that portions of the computing environment may be implemented using one or more processing platforms. A given such processing platform comprises at least one processing device comprising a processor coupled to a memory, and the processing device may be implemented at least in part utilizing one or more virtual machines, containers or other virtualization infrastructure. By way of example, such containers may be Docker containers or other types of containers.

The particular processing operations and other system functionality described in conjunction with FIGS. 1-6 are presented by way of illustrative example only, and should not be construed as limiting the scope of the disclosure in any way. Alternative embodiments can use other types of operations and protocols. For example, the ordering of the steps may be varied in other embodiments, or certain steps may be performed at least in part concurrently with one another rather than serially. Also, one or more of the steps may be repeated periodically, or multiple instances of the methods can be performed in parallel with one another.

It should again be emphasized that the above-described embodiments of the invention are presented for purposes of illustration only. Many variations may be made in the particular arrangements shown. For example, although described in the context of particular system and device configurations, the techniques are applicable to a wide variety of other types of data processing systems, processing devices and distributed virtual infrastructure arrangements. In addition, any simplifying assumptions made above in the course of describing the illustrative embodiments should also be viewed as exemplary rather than as requirements or limitations of the invention.

What is claimed is:

1. An apparatus comprising:
at least one processing device comprising a processor coupled to a memory, the at least one processing device, when executing program code, is configured to:
obtain a plurality of datasets respectively representing a plurality of probability measures for a plurality of variability factors associated with a supply chain for at least one part needed to manufacture equipment; and
generate a prediction for a future shortage of the at least one part based on the plurality of datasets.

2. The apparatus of claim 1, wherein a given one of the probability measures for a given one of the variability factors comprises an indicator of a likelihood of a future shortage occurring due to a previous commitment failure by a given supplier to provide the at least one part.

3. The apparatus of claim 1, wherein a given one of the probability measures for a given one of the variability factors comprises an indicator of a likelihood of a future shortage occurring due to a previous shortage of the at least one part at a given factory manufacturing the equipment.

4. The apparatus of claim 1, wherein a given one of the probability measures for a given one of the variability factors comprises an indicator of a likelihood of a future shortage occurring due to real-time data for the at least one part from a global demand supply model.

5. The apparatus of claim 1, wherein a given one of the probability measures for a given one of the variability factors comprises an indicator of a likelihood of a future shortage occurring due to real-time data for the at least one part from a data feed of a given factory manufacturing the equipment.

6. The apparatus of claim 1, wherein a given one of the probability measures for a given one of the variability factors comprises an indicator of a likelihood of a future shortage occurring due to real-time data for the at least one part from at least one market information source.

7. The apparatus of claim 1, wherein the at least one processing device, when executing program code, is further configured to generate the prediction for a future shortage of the at least one part by respectively deriving a plurality of weights for the plurality of datasets.

8. The apparatus of claim 7, wherein the at least one processing device, when executing program code, is further configured to derive the plurality of weights for the plurality of datasets using a Bayesian network.

9. The apparatus of claim 7, wherein the at least one processing device, when executing program code, is further configured to generate the prediction for a future shortage of the at least one part by applying the plurality of weights in a regression algorithm to generate the prediction.

10. The apparatus of claim 1, wherein the plurality of variability factors comprise a demand planning factor, a supply planning factor, a supply commitment factor, a supplier commitment versus shipment history factor, a factory inventory feed factor, a market update factor, and a part shortage history by facility factor.

11. The apparatus of claim 10, wherein the at least one processing device, when executing program code, is further configured to obtain the plurality of datasets by applying an ensemble of artificial intelligence-based models to the plurality of variability factors.

12. A method comprising:
obtaining a plurality of datasets respectively representing a plurality of probability measures for a plurality of variability factors associated with a supply chain for at least one part needed to manufacture equipment; and
generating a prediction for a future shortage of the at least one part based on the plurality of datasets.

13. The method of claim 12, wherein a given one of the probability measures for a given one of the variability factors comprises an indicator of a likelihood of a future shortage occurring due to a previous commitment failure by a given supplier to provide the at least one part.

14. The method of claim 12, wherein a given one of the probability measures for a given one of the variability factors comprises an indicator of a likelihood of a future shortage occurring due to a previous shortage of the at least one part at a given factory manufacturing the equipment.

15. The method of claim 12, wherein a given one of the probability measures for a given one of the variability factors comprises an indicator of a likelihood of a future shortage occurring due to real-time data for the at least one part from a global demand supply model.

16. The method of claim 12, wherein a given one of the probability measures for a given one of the variability factors comprises an indicator of a likelihood of a future shortage occurring due to real-time data for the at least one part from a data feed of a given factory manufacturing the equipment.

17. The method of claim 12, wherein a given one of the probability measures for a given one of the variability factors comprises an indicator of a likelihood of a future shortage occurring due to real-time data for the at least one part from at least one market information source.

18. A computer program product comprising a non-transitory processor-readable storage medium having stored therein program code of one or more software programs, wherein the program code when executed by at least one processing device cause the at least one processing device to:
obtain a plurality of datasets respectively representing a plurality of probability measures for a plurality of variability factors associated with a supply chain for at least one part needed to manufacture equipment; and
generate a prediction for a future shortage of the at least one part based on the plurality of datasets.

19. The computer program product of claim 18, wherein the plurality of variability factors comprise a demand planning factor, a supply planning factor, a supply commitment factor, a supplier commitment versus shipment history factor, a factory inventory feed factor, a market update factor, and a part shortage history by facility factor.

20. The computer program product of claim 19, wherein obtaining the plurality of datasets further comprises applying an ensemble of artificial intelligence-based models to the plurality of variability factors.
